(19) United States
(12) Patent Application Publication
(10) Pub. No.: US 2018/0268328 A1
(43) Pub. Date: Sep. 20, 2018

(54) System and Method for Communication Routing, Transportation Coordination and Product Creation

(71) Applicant: ClusterTruck Holdings, LLC, Indianapolis, IN (US)

(72) Inventors: Chris Baggott, Indianapolis, IN (US); Dan McFadden, Indianapolis, IN (US)

(21) Appl. No.: 15/986,590

(22) Filed: May 22, 2018

Related U.S. Application Data
(63) Continuation of application No. 15/655,793, filed on Jul. 20, 2017, now abandoned.
(60) Provisional application No. 62/356,370, filed on Jun. 29, 2016.

(51) Int. Cl. G06Q 10/04; G06Q 10/08; G06Q 50/12; G06Q 30/06

(52) U.S. Cl. CPC G06Q 10/047; G06Q 10/08355; G06Q 50/12; G06Q 30/0635; G06Q 10/0832

(57) ABSTRACT

A system and method for communication routing, transportation coordination and product creation, based on the number of delivery agents and the need for delivery of an order placed through a customer order placement application, the method includes receiving a communication for each of the plurality of delivery agents comprising a delivery agent location, determining a delivery agent arrival time for pickup of the order, and based at least partially on the arrival time, transmitting, by the communication router over the communication network to the manager application, an instruction communication to begin preparation of each of the items at the respective preparation start time for each of the items so that completion of preparation of each of the items in the order substantially coincides with the completion of preparation of each of the other items in the order and coincides with the arrival time of the delivery agent.

### CROSS-REFERENCE TO RELATED APPLICATIONS

The present application is a U.S. Continuation Utility patent application, which claims priority to U.S. Non-Provisional Utility patent application Ser. No. 15/655,793, filed Jul. 20, 2017 and U.S. Provisional Patent Application Ser. No. 62/364,370, filed Jul. 20, 2016, which application is incorporated in its entirety, by reference herein.

### TECHNICAL FIELD

This patent application relates to computerized systems and methods for communication routing, transportation coordination and product creation.

### BACKGROUND

Current food delivery models rely on an imperfect method for delivering food to customers. The current models feature the same or similar underlying process of a customer placing an order for food, the food is then cooked/prepared, and the food is then delivered to the customer. The problem with such models is that the communication and coordination between ordering, cooking/preparation, and delivery, is inefficient. This leads to a variety of problems including delivery of poor quality food (e.g. food being cold upon delivery), food being delayed, or poor profits for business offering food delivery services.

Many delivery models attempt to tackle these problems by adopting various food ordering, preparation, and delivery methods. For example, one approach is the “middleman” approach to food delivery, where a business acts as the middleman between a restaurant and customer. Other delivery models include overstaffing delivery drivers, so that delivery drivers are always available on standby; yet other deliver models use prophylactic methods such as incorporating specialized vehicles to prolong the quality of foods so that they maintain their quality during long delivery times.

Despite these attempts, these models still face problems high operating costs, arising from having to pay for large fleets of drivers; varying order mechanisms; and attrition on the part of the workforce (e.g. the turnover for delivery drivers in the food delivery industry leads to higher costs for business because companies need to keep training new workforce members).

Therefore, there is a need for an improved computerized systems and methods for communication routing, transportation coordination and product creation.

### SUMMARY

The present application discloses a plurality of embodiments directed to computerized systems and methods for communication routing, transportation coordination and product creation.

In one embodiment, a method is disclosed for transmitting an instruction communication to a manager application from a server including a communication router coupled to a communication network, for preparation and delivery of an order placed through a customer order placement application in communication with the server, the instruction communication being based upon information received from a delivery agent application associated with each of a plurality of delivery agents, the method comprising the steps of: receiving, at the server, an order communication from the customer order placement application, the order communication comprising an order for one or more items placed by a customer for delivery to a delivery destination; determining, by the server, an estimated preparation time for each of the one or more items; receiving, at the server, an availability communication from the delivery agent application for a first one of the plurality of delivery agents, the availability communication comprising a delivery agent status; receiving, at the server, a location communication from at least one of: a device associated with the first one of the plurality of delivery agents or the delivery agent application for the first one of the plurality of delivery agents, the location communication comprising a location of the first one of the plurality of delivery agents; determining, at the server, an estimated arrival time of the first one of the plurality of delivery agents at a pickup location based at least in part on the location of the first one of the plurality of delivery agents; determining, at the server, a preparation start time for each of the at least one items in the order such that preparation of the each of the at least one items is completed substantially simultaneously to each of the other at least one items, and substantially simultaneously with the estimated arrival time of the first one of the plurality of delivery agents at the pickup location; and transmitting, by the communication router, an instruction communication over the communication network to the manager application to begin preparation of each of the at least one items at the preparation start time for each of the at least one item.

In another embodiment, the order comprises a food order, the one or more items comprises one or more food items, and the manager application comprises a kitchen manager application.

In another embodiment, the method further comprises the step of receiving from the manager application, at the server, a confirmation communication when each of the at least one items of the order has been prepared.

In another embodiment, the method further comprises the step of assigning, by the server, the order to the first one of the plurality of delivery agents.

In another embodiment, wherein the preparation start time for each of the one or more items equals the estimated arrival time of the first one of the plurality of delivery agents at the pickup location, minus a predetermined preparation time for each of the one or more items.

In another embodiment, a method is disclosed for transmitting an instruction communication to a manager application from a server including a communication router coupled to a communication network, for preparation and delivery of an order placed through a customer order placement application in communication with the server, the server further operative to communicate over the communications network with a plurality of delivery agent applications associated with each of a plurality of delivery agents, the method comprising the steps of: receiving, at the server, an order communication from the customer order placement application, the order communication comprising an order for one or more items placed by a customer for delivery to a delivery destination; communicating, by the server, with at least one of: a device associated with a delivery agent or one of the plurality of delivery agent applications associated with the delivery agent, and determining based on the communication the arrival time of the delivery agent at a pickup location; determining, at the server and based at least partially on the arrival time, a preparation start time for each of the one or more items; and transmitting, by the communication router over the communication network to the manager application, an instruction communication to begin preparation of each of the one or more items at the respective preparation start time for each of the one or more items so that completion of preparation of each of the one or more items in the order substantially coincides with the completion of preparation of each of the other items in the order and coincides with the arrival time of the delivery agent.

In another embodiment, the order comprises a food order, the one or more items comprises one or more food items, and the manager application comprises a kitchen manager application.

In another embodiment, the method further comprises retrieving, by the server, data from a database regarding an estimated preparation time for each of the one or more items, wherein step (c) further comprises determining, at the server and based at least partially on the arrival time and the estimated preparation time, a preparation start time for each of the one or more items.

In another embodiment, the method further comprises receiving, at the server, an availability communication from the delivery agent application associated with the delivery agent, the availability communication comprising a delivery agent status.

In another embodiment, the method further comprises receiving from the manager application, at the server, a confirmation communication when each of the at least one items of the order has been prepared.

In another embodiment, the method further comprises storing data in a database regarding a measured preparation time for each of the one or more items based upon the confirmation communication.

In another embodiment, the method further comprises using said data to determine the estimated preparation time for each of the one or more items.

In another embodiment, the method further comprises assigning, by the server, the order to the delivery agent.

In another embodiment, the preparation start time for each of the one or more items equals the arrival time of the delivery agent at the pickup location, minus a predetermined preparation time for each of the one or more items.

In another embodiment, the method further comprises receiving geolocation information from the delivery agent application.

In another embodiment, the method further comprises determining route information obtained from a database containing at least one route information.

In another embodiment, the method further comprises determining route information obtained from a database containing at least one route information and at least one traffic congestion information.

In another embodiment, a computerized system coupled to a communication network is disclosed, the system operative for assignment of an order to a delivery agent, the system comprising: a customer order placement application; a server for receiving an order communication from the customer order placement application over the communication network, the order communication comprising an order for one or more items placed by a customer for delivery to a delivery destination; a database of item information comprising the time for completion of each of the one or more items; an order queue for establishing a preparation sequence for each of the one or more items in each order based at least upon the time for completion of each of the one or more items; and a plurality of delivery agent applications operative to send a plurality of communications over the communication network to the server, wherein each of the plurality of communications from the plurality of delivery agent applications comprises information regarding the location of the respective one of the plurality of delivery agent applications; wherein the server identifies a delivery agent to pick up the order and an associated arrival time based at least in part on information in the plurality of communications and the order queue; the server determines, based at least in part on the arrival time, a preparation start time for each of the one or more items; and wherein the server is operative to transmit, by the communication router over the communication network to the manager application, an instruction communication to begin preparation of each of the one or more items at the respective preparation start time for each of the one or more items so that completion of preparation of each of the one or more items in the order substantially coincides with the completion of preparation of each of the other items in the order and coincides with the arrival time of the delivery agent.

In another embodiment, a first delivery agent application suitable to fulfill the delivery of the order is selected from the plurality of delivery agent applications, based at least in part on a pre-determined criterion.

In another embodiment, the pre-determined criterion comprises a proximity of one of a device associated with the delivery agent or the first delivery agent application to a location where the order is completed.

In another embodiment, the pre-determined criterion comprises a length of time to travel a location of the first delivery agent application to a location where the order is completed.

In another embodiment, the pre-determined criterion comprises a transportation mode associated with the first delivery agent application.

In another embodiment, the server is operative to send an activation communication to the first delivery agent application and, if the first delivery agent application does not communicate an acceptance indication to the server, a second delivery agent application suitable to fulfill the delivery of the order is selected from the plurality of delivery agent applications based at least on the pre-determined criterion.

In another embodiment, the second delivery agent application communicates an acceptance indication to the server, and the server is operative to assign the order to the second delivery agent application for delivery to the customer.

In another embodiment, the order comprises a food order, the one or more items comprises one or more food items, and the manager application comprises a kitchen manager application.

In another embodiment, the server determines, based at least in part on the arrival time and the time for completion of each of the one or more items, a preparation start time for each of the one or more items.

In another embodiment, each of the plurality of delivery agent applications is configured to transmit to the server over the communication network, an availability communication, the availability communication comprising a delivery agent status.

In another embodiment, the manager application is configured to transmit to the server over the communication network, a confirmation communication when each of the at least one items of the order has been prepared.

In another embodiment, the server is configured to store data in a database regarding a measured preparation time for each of the one or more items based upon the confirmation communication.

In another embodiment, the server is configured to use said data to determine the estimated preparation time for each of the one or more items.

### BRIEF DESCRIPTION OF THE DRAWINGS

FIG. 1 is a schematic system diagram of a system for communication routing, transportation coordination and product creation in accordance with an embodiment;

FIG. 2A is a schematic flowchart of a method for coordinating food preparation and delivery according to an embodiment;

FIG. 2B is a schematic timeline flowchart of a method for coordinating food preparation and delivery according to an embodiment;

FIG. 3 is a schematic timeline flowchart of a method for coordinating food preparation and delivery according to an embodiment; and

FIG. 4 is a schematic flowchart of a method for coordinating food preparation and delivery according to an embodiment.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

Although many of the illustrated embodiments are described in conjunction with the specific domains of food creation and transportation, the present embodiments will find application in any field where products are ordered, created and/or transported.

This detailed description is presented in terms of programs, data structures or procedures executed on a computer or network of computers. The software programs implemented by the system 100 may be written in any programming language—interpreted, compiled, or otherwise. These languages may include, but are not limited to, Xcode, iOS, cocoa, cocoa touch, MacRuby, PHP, ASP.net, HTML, HTMLS, Ruby, Perl, Ember.js, Java, Python, C++, C#, JavaScript, and/or the Go programming language. It should be appreciated, of course, that one of skill in the art will appreciate that other languages may be used instead, or in combination with the foregoing and that web and/or mobile application frameworks may also be used, such as, for example, Ember.js, Ruby on Rails, Node.js, Zend, Symfony, Revel, Django, Struts, Spring, Play, Jo, Twitter Bootstrap and others. It should further be appreciated that the system 100s and methods disclosed herein may be embodied in software-as-a-service available over a computer network, such as, for example, the Internet. Further, the present disclosure may enable web services, application programming interfaces and/or service-oriented architecture through one or more application programming interfaces or otherwise.

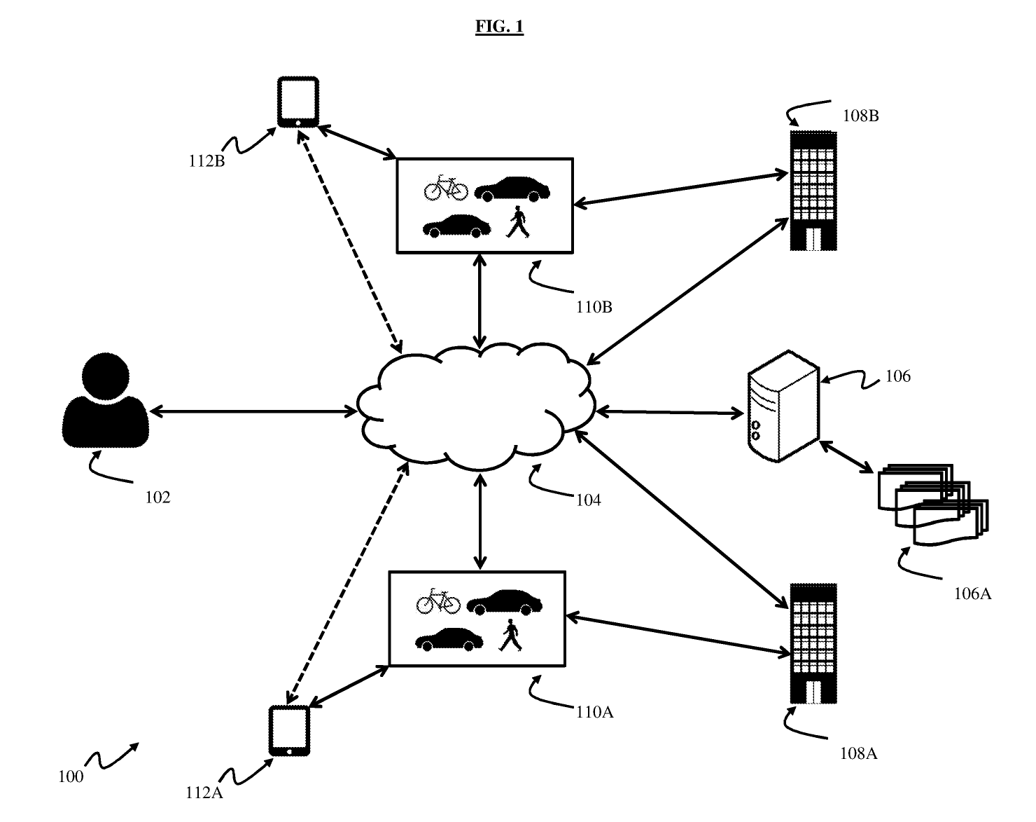

FIG. 1 shows a system for communication routing, transportation coordination and product creation as used in the field of coordinating food preparation and delivery, generally indicated at 100. In at least one embodiment of the present disclosure, the system 100 includes a customer order placement application 102, a communication network 104, a server 106, an order queue 106A, a kitchen manager application 108A, and a delivery agent application 110A.

In at least one embodiment of the present disclosure, the system 100 includes the customer order placement application 102 accessed via a customer device. The customer device includes one or more computers, smartphones, tablets, wearable technology, computing devices, or systems of a type well known in the art, such as a mainframe computer, workstation, personal computer, laptop computer, hand-held computer, cellular telephone, MP3 player, personal digital assistant, or any other device having computational capability. The customer device includes such software, hardware, and componentry as would occur to one of skill in the art, such as, for example, one or more microprocessors, memory systems, input/output devices, device controllers, location systems, and the like. The customer device also comprises one or more data entry means (not shown in FIG. 1) operable by users of the customer device for data entry, such as, for example, voice or audio control, a pointing device (such as a mouse), keyboard, touchscreen, microphone, voice recognition, and/or other data entry means known in the art. The customer device also comprises a display means which may comprise various types of known displays such as liquid crystal diode displays, light emitting diode display, and the like upon which information may be displayed in a manner perceptible to the customers. It will be appreciated that customer device may further comprise such software, hardware, and componentry as would occur to one of skill in the art, to operably perform the functions allocated to the customer order placement application 102 in accordance with the present disclosure. It will be further appreciated that the customer device and/or customer order placement application 102 may be configured to route communications (i.e., transmit information) to and generally interact with a web service and/or application programming interface infrastructure housed on server 106 over communication network 104. The customer device and/or customer order placement application 102 may include a web browser, mobile application, socket or tunnel, or other network connected software such that communication with the web services infrastructure on server 106 is possible over the communication network 104.

In at least one embodiment of the present disclosure, the system 100 includes server 106. Server 106 comprises one or more server computers, storage systems, computing devices, or systems of a type known in the art. Server 106 further comprises such software, hardware, and componentry as would occur to one of skill in the art, such as, for example, microprocessors, memory systems, input/output devices, device controllers, display systems, and the like. Server 106 may comprise one of many well-known servers and/or platforms, such as, for example, IBM's AS/400 Server, RedHat Linux, IBM's AIX UNIX Server, MICROSOFT's WINDOWS NT Server, AWS Cloud services, Rackspace cloud services, any infrastructure as a service provider, web services infrastructure, or any platform as a service provider. It will be appreciated that server 106 is configured to store information generated by the system 100 and/or retrieved from one or more information sources, to operably perform the functions allocated to the server 106 in accordance with the present disclosure.

In FIG. 1, server 106 is shown and referred to herein as a single server. However, server 106 may comprise a plurality of servers, virtual infrastructure, or other computing devices or systems interconnected by hardware and software systems know in the art which collectively are operable to perform the functions allocated to server 106 in accordance with the present disclosure. For example, server 106 may include software systems/components such as a communication router (not separately illustrated) and an order queue 106A.

In at least one embodiment of the present disclosure, the system 100 includes an order queue 106A. The order queue 106A is configured to store information generated by the system 100 and/or retrieved from one or more information sources, and to operably perform the functions allocated to the order queue 106A in accordance with the present disclosure. In at least one embodiment of the present disclosure, order queue 106A can be “associated with” server 106 where order queue 106A resides on server 106. Order queue 106A can also be “associated with” server 106 where order queue 106A resides on a server or computing device remote from server 106, provided that the remote server or computing device is capable of bi-directional communication routing (i.e., data transfer) with server 106, such as, for example, in Amazon AWS, Rackspace, or other virtual infrastructure, or any business network. In at least one embodiment of the present disclosure, the remote server or computing device upon which order queue 106A resides is electronically connected to server 106 such that the remote server or computing device is capable of continuous bi-directional communication routing (data transfer) with server 106.

For purposes of clarity, order queue 106A is shown in FIG. 1, and referred to herein as a single queue. It will be appreciated by those of ordinary skill in the art that order queue 106A may comprise a plurality of queues connected by software systems of a type well known in the art, which collectively are operable to perform the functions delegated to order queue 106A according to the present disclosure. Order queue 106A may also be part of distributed data architecture, such as, for example, a Hadoop architecture, for big data services. Order queue 106A may comprise relational database architecture, noSQL, OLAP, or other database architecture of a type known in the database art. Order queue 106A may comprise one of many well-known database management systems, such as, for example, MICROSOFT's SQL Server, MICROSOFT's ACCESS, MongoDB, JCR, Redis. Hadoop, or IBM's DB2 database management systems, or the database management systems available from ORACLE or SYBASE. Order queue 106A retrievably stores information that is communicated to order queue 106A from customer device 102 or server 106.

In at least one embodiment of the present disclosure, the system 100 includes or operates in conjunction with a kitchen manager application 108A in a kitchen facility (not shown). The kitchen facility serves as a central distribution center, and includes a plurality of cooking and food processing and preparation stations (not shown) sometimes also referred to herein as food stations. It is within the scope of this disclosure that the kitchen facility may include a single food station. Each of the plurality of food stations include a food station manager application, each of which is intended to coordinate the preparation of order items at the particular food station, providing instructions regarding which items from which order to prepare and when. In one embodiment, the instructions may be issued by order queue 106A and sent using a communication router of system 100 to the applicable food station manager application(s). In some embodiments, the instructions may be issued by order queue 106A and sent using a communication router of system 100 to the kitchen manager application 108A, which then sends appropriate instructions to the applicable food station manager application(s). The food station manager application may further be configured to provide information regarding when to wait to perform a particular act (such as dropping French fries into the fryer), and may further be configured to receive inputs from an operator such as reporting when a task is complete, reporting problems with equipment, low food supply, or delays. It is within the scope of the present disclosure for the food station manager application(s) to be part of the same subsystem as the kitchen manager application 108A, or to be separate subsystems in communication with the kitchen manager application 108A, as would be understood by one of ordinary skill in the art.

By way of example, food stations may include a plurality of equipment and perform functions of food preparation activities such as a salad bar, pizza, sandwich, broiler, flattop or griddle, grille, pasta, and saute, to name a few non-limiting examples. Each of the food stations may be manned by a workforce member, or may be automated to perform one or more of the functions delegated, assigned, or otherwise allocated to the kitchen manager application, and the food station manager applications therein, according to the present disclosure. For clarity, functions may be delegated to more than one food station manager application.

In at least one embodiment of the present disclosure, the kitchen facility further includes an expo station (not shown), an assembly station (not shown), and a runner station (not shown). Each such station may have one or more food station manager applications. The expo station is configured to provide oversight of the kitchen's and kitchen manager application's 108A operations. For example, the expo station might allow for a centralized location for the management of orders, coordination of kitchen staff, and the like. The assembly station is configured to allow the coordination and preparation of food orders. The runner station is configured to allow additional resources to help assist in the coordination of food preparation.

In at least one embodiment of the present disclosure, each of the plurality of food station manager applications and the kitchen manager application 108A may comprise computers or terminals for the instantaneous display of information and for the routing of communications to and from other portions of the system 100. For example, the each of the plurality of food station manager applications in the kitchen may include one or more data entry means (not shown in FIG. 1) operable by the workforce members of the kitchen, such as, for example, voice or audio control, a pointing device (such as a mouse), keyboard, touchscreen, microphone, voice recognition, and/or other data entry means known to one having ordinary skill in the art. Each of the plurality of food stations in the kitchen may also include a display means which may comprise various types of known displays such as liquid crystal diode displays, light emitting diode display, and the like upon which information may be displayed in a manner perceptible to the user. It will be appreciate that the each of the plurality of food stations and food station manager applications in the kitchen and the kitchen manager application 108A may be integrated and may further include such software, hardware, and componentry as would occur to one of skill in the art, to operably perform the functions allocated to the kitchen and the kitchen manager application 108A, and the food stations and food station manager applications therein, in accordance with the present disclosure. It will be further appreciated that the each of the plurality of food station manager applications in the kitchen may be configured to route communications (i.e., transmit information) to and generally communicate with each other food station manager application in the kitchen (optionally, through the kitchen manager application 108A), and with a web service and/or application programming interface infrastructure housed on server 106 either directly connected or connected over communication network 104. It will be appreciated by one of ordinary skill in the art that one or more additional kitchens (e.g. with kitchen manager application 108B) may be associated with system 100, and the each of the plurality of kitchens may be located remotely from each other, and operably configured to perform the functions allocated to a kitchen, in accordance with the present disclosure.

In at least one embodiment of the present disclosure, the system 100 includes at least one delivery agent application 110A associated with a delivery agent. It will be appreciated that a delivery agent application 110A may include a plurality of delivery agent applications and the associated delivery agents connected by software systems of a type well known in the art, which collectively are operable to perform the functions delegated to the delivery agent application 110A, according to the present disclosure. It will be further appreciated that the delivery agent application 110A may also be associated with delivery agents that are devices such as drones, autonomous vehicles, and the like, to name a few non-limiting examples. The delivery agent associated with delivery agent application 110A provides transportation services of the food items produced within the kitchen in the system 100.

In at least one embodiment of the present disclosure, the delivery agent application 110A includes such software, hardware, and componentry as would occur to one of skill in the art, such as, for example, one or more microprocessors, memory systems, input/output devices, device controllers, and the like. It will be appreciated that the delivery agent application 110A is capable of transmitting location information, receiving instructions, transmitting payment information, communicating, or otherwise being operably connected to a web service and/or application programming interface infrastructure housed on server 106 over communication network 104.

It will be further appreciated that each delivery agent application 110A may be associated with a plurality of transportation modes and means, such as, for example, a car, a bicycle, an unmanned aerial vehicle, a pedestrian, or a customized delivery vehicle (e.g. a refrigerated truck, a heated truck, etc.). The each delivery agent application 110A may further include other characteristics such as payload transport abilities, speed, distance ranges, fuel efficiency, and the like. It will be further appreciated that each delivery agent application 110A is attributed with delivery attributes, such as for example, the speed of the delivery agent associated with delivery agent application 110A (whether based on historical metrics, transportation mode selected, traffic and other route information, or other considerations), a ranking of the delivery agent (such as by system 100 regarding the availability and work habits of the associated delivery agent), the delivery range attributed to the delivery agent, the customer satisfaction ratings of the delivery agent associated with the delivery agent application 110A, and the like.

In at least one embodiment of the present disclosure, the each delivery agent application 110A has delivery attributes to help the system 100 evaluate and select an appropriate delivery agent for the delivery of food orders. For example, a delivery agent application 110A that is associated with the driver of a car can generally transport more food items to further distances, when compared to a delivery agent application 110A that is associated with a pedestrian. Continuing with this example, if an order comprises ten pizzas, the system 100 may prefer to select a driver in a car associated with delivery agent application 110A. In yet another example, it may be more efficient to use a pedestrian associated with delivery agent application 110A, than a driver in a car, such as, when the delivery location is near the physical location of kitchen or when vehicular traffic congestion exists. In another example, a refrigerated vehicle can keep cold food items (e.g. ice cream) refrigerated, when compared to a bicycle, thereby making a refrigerated vehicle more appropriate as the means of delivery selected for orders of ice cream (or other items requiring refrigeration). It will be appreciated that the system 100 may track these delivery attributes for each delivery agent application 110A.

Although only one delivery agent application 110A is shown, it will be appreciated by one having ordinary skill in the art that a plurality of delivery agents each associated with delivery agent applications (e.g. delivery agent application 110B) may be available, and the each of the plurality of delivery agent applications may be located remotely from each other, and operably configured to perform the functions allocated to the delivery agent application 110, in accordance with the present disclosure.

In at least one embodiment of the present disclosure, the system 100 further includes one or more delivery agent devices (e.g., 112A and 112B). The delivery agent device 112A and 112B includes one or more computers, smartphones, tablets, wearable technology, computing devices, or systems of a type well known in the art, such as a mainframe computer, workstation, personal computer, laptop computer, hand-held computer, cellular telephone, MP3 player, or personal digital assistant. The delivery agent device 112A and 112B may be configured to operate or interact with the delivery agent application 110A, and include such software, hardware, and componentry as would occur to one of skill in the art, such as, for example, one or more microprocessors, memory systems, input/output devices, device controllers, and the like. The delivery agent device 112A and 112B may include one or more data entry means (not shown in FIG. 1) operable by delivery agents associated with delivery agent applications 110A and 110B, respectively, of the delivery agent device 112A and 112B, for data entry, such as, for example, voice or audio control, a pointing device (such as a mouse), keyboard, touchscreen, microphone, voice recognition, and/or other data entry means known in the art. The delivery agent device 112A and 112B may also include a display means which may comprise various types of known displays such as liquid crystal diode displays, light emitting diode display, and the like upon which information may be displayed in a manner perceptible to the users. It will be appreciated that delivery agent device 112A and 112B include may further include such software, hardware, and componentry as would occur to one of skill in the art, to operably perform the functions allocated to the delivery agent device 112A and 112B in accordance with the present disclosure. It will be further appreciated that the delivery agent device 112A and 112B may be configured to route communications (i.e., transmit information) to and generally interact with a web service and/or application programming interface infrastructure housed on server 106 over communication network 104. The delivery agent device 112A and 112B may include a web browser, mobile application, socket or tunnel, or other network connected software such that communication with the web services infrastructure on server 106 is possible over the communications network 104.

One embodiment of system 100 includes a customer order placement application 102 for use by a customer for placing a food order, a server 106 configured to communicate with the customer customer order placement application 102 over communication network 104, the order being received at the server 106 over communication network 104, the server 106 storing information in a database, or in order queue 106A. The food order is further processed and set for preparation by a kitchen manager application 108A, and assigned to a delivery agent associated with a delivery agent application 110A for delivery to the customer.

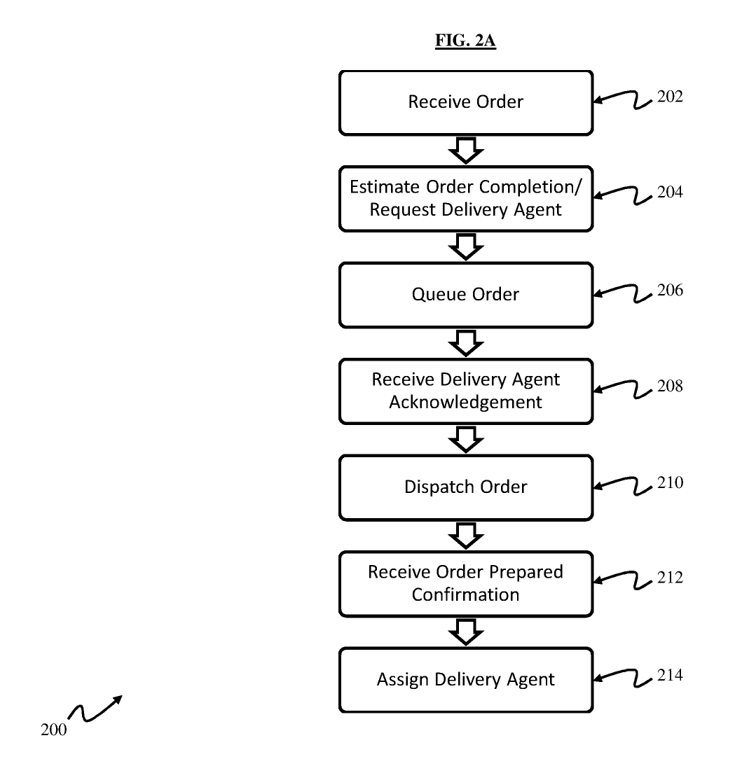

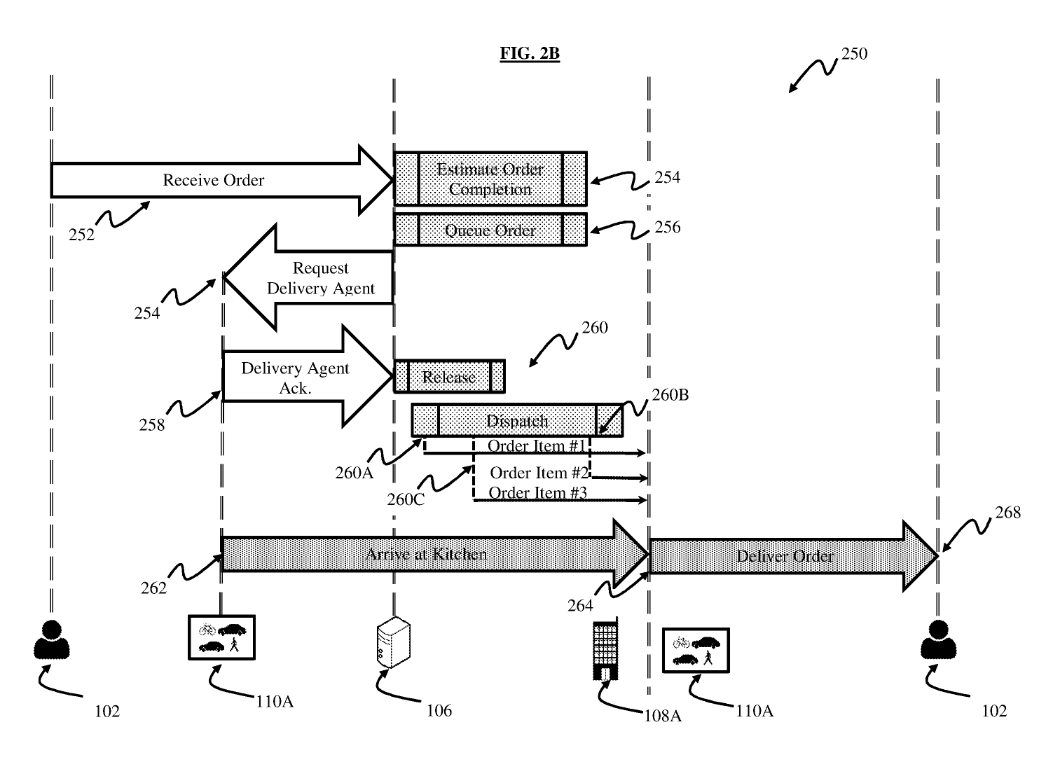

Referring now to FIG. 2A, there is shown a method for coordinating food preparation and delivery, generally indicated at 200. The method 200 includes receiving an order at step 202; estimating an order completion time, and requesting a delivery agent at step 204; queueing the order at step 206; receiving a delivery agent acknowledgement at step 208; dispatching the order at step 210; receiving order preparation completion confirmation at step 212, and assigning a delivery agent at step 214.

In at least one embodiment of the present disclosure, the method 200 includes receiving an order, at step 202. An order for food items may be created by a customer using customer order placement application 102 and transmitted to server 106 via communication network 104. For example, a customer may add food items to an online shopping cart on an online food ordering interface (i.e., the customer order placement application 102), whereby the system 100 creates (or updates) an order to add the items to the order. Continuing with this example, order confirmation happens at checkout time when the customer pays for the order.

In at least one embodiment of the present disclosure, each order includes a delivery address. The delivery address may be obtained via input from the customer, or via an automated pull of the customer order placement application 102's GPS coordinates. It will be appreciated that the customer may be able to set delivery locations, preferences (e.g. work location, home location), and provide delivery instructions, to help simplify and facilitate a faster ordering process. In at least one embodiment of the present disclosure, the GPS coordinates may be compared to a predetermined delivery range to determine whether to allow the customer to place an order or to alert the customer that they are not currently in the delivery range and need to establish a delivery address within the delivery range prior to completing an order. In at least one embodiment of the present disclosure, each order includes a requested delivery time for delivery to the delivery address.

In at least one embodiment of the present disclosure, the system 100 is configured to transmit an order confirmation communication from the server 106 to the customer order placement application 102 via the communication network 104. System 100 may be configured to transmit additional information via the communication network 104 such as order status, delays, delivery agent location, delivery agent arrival, customer satisfaction and feedback requests, and the like.

In at least one embodiment, the customer may track the progress of the order via customer order placement application 102. For example, the customer order placement application 102 may receive notifications from the server 106 via the communication network 104, or the customer order placement application 102 may be able to poll (or otherwise pull information) from the server 106 via the communication network 104. It will be further appreciated that the system 100 allows for a customer to track delivery in real-time, including the location of the delivery agent associated with delivery agent application 110A, during the course of delivery of the order. It will be appreciated that the tracking may occur via map, text messages and the like, phone calls, app notifications, or other means well known to one having ordinary skill in the art. For example, using the customer order placement application 102, a customer may be able to view the delivery agent's 112 location information on a map that updates with real-time or near-real-time location information. It will be appreciated that this enables the customer to be ready for the delivery of the customer's order.

In at least one embodiment of the present disclosure, the method 200 includes estimating an order completion time, and requesting a delivery agent, at step 204. For each order received, the system 100 calculates the expected cook time for each item of the order. For example, if an order has five different items, the system 100 is configured to calculate the amount of time it will take to cook all five items, either in sequence or in parallel, and to estimate the time to completion for all of the items in the order.

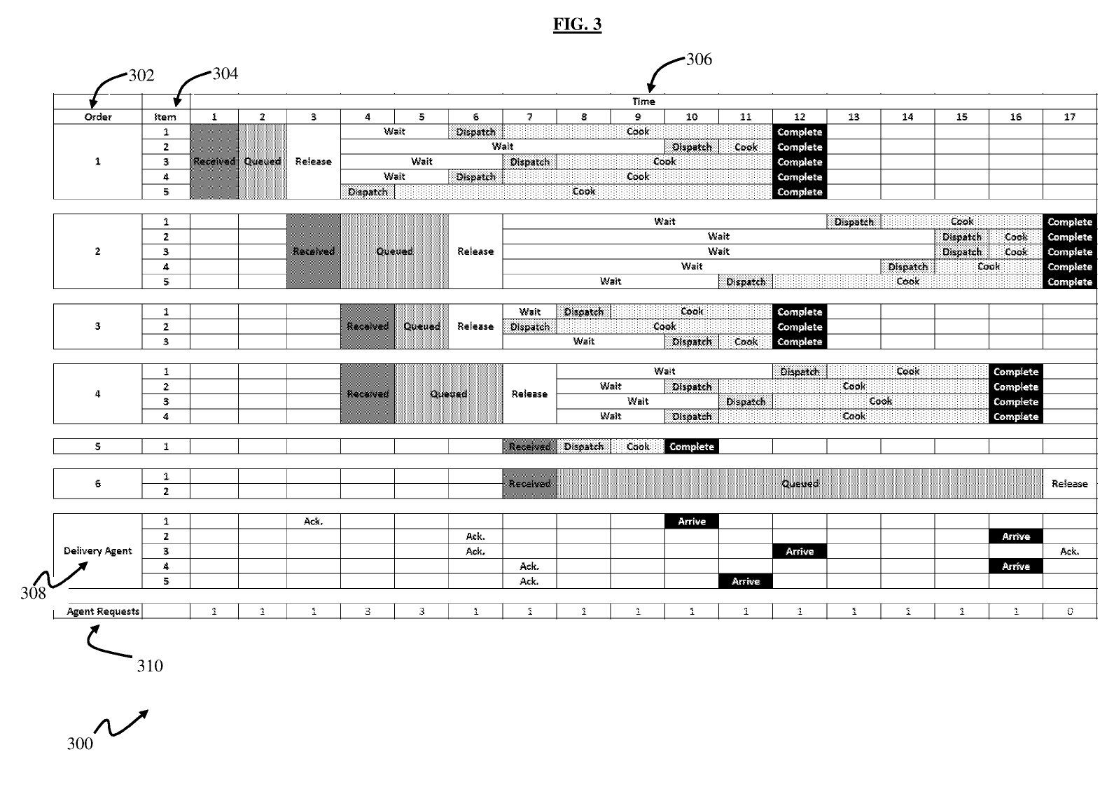

To further illustrate an exemplary embodiment of the method 200, there is shown a flowchart 300 in FIG. 3. Flowchart 300 includes a plurality of orders 302 (i.e., order 1, order 2, order 3, order 4, order 5, and order 6); a plurality of order items 304 for the each of the plurality of orders 302, a time line 306 comprising seventeen time periods, a list of delivery agents 308 (i.e. delivery agent 1, delivery agent 2, delivery agent 3, delivery agent 4, and delivery agent 5), and a count of outstanding delivery agent requests 310. Each of the plurality of orders 302 includes one or more order items 304. For example, order 1 includes five items; order 2 includes five items; order 3 includes three items; order 4 includes four items; order 5 includes one item; and order 6 includes two items. Continuing with order 1 as an example, the system 100 is configured to calculate the amount of time it will take to cook all five items in order 1. As shown in flowchart 300, order 1, item 5 requires the longest cook time (eight time periods) amongst all the items in order 1. Similarly, order 1, item 2 requires the shortest cook time (two time periods). When the each of the five items in order 1 are cooked in parallel, the system 100 determines that the cook time will be approximately eight time periods (because of the longest duration of item 5). In one embodiment, the kitchen manager application 108A makes these determinations and then calculates the wait times before dispatching the item to the appropriate food station for each item in the order. The wait times are calculated such that all items in the order will complete cooking at the same time, such that the order is ready for pick up by a delivery agent when all items have been recently completed. In at least one embodiment of the present disclosure, the requested delivery time is also used to determine wait times.

In at least one embodiment of the present disclosure, step 204 further includes requesting a delivery agent. The system 100 is configured to issue a request for a delivery agent to delivery agent application 110A by routing an activation communication to delivery agent application 110A over the communication network 104. For example, a plurality of delivery agents may be available to perform a delivery of an order. The system 100 may issue an activation communication to a delivery agent in the form of a ‘push’ notification over the communication network 104 to the delivery agent application 110A (e.g., accessed via the delivery agent device 112A) associated with a delivery agent that is nearest to the kitchen facility, as determined by the delivery agent's (or more particularly the delivery agent application's 110A and/or device's 112A) location relative to the kitchen facility. In at least one embodiment of the present disclosure, the system 100 is configured to ‘push’ notifications to alternative delivery agents' applications 110A (if the first selected delivery agent does not respond with an availability communication), the alternative delivery agents selected by increasing distance of the delivery agent from the kitchen facility. For example, the second closest delivery agent might get the second ‘push’ notification routed to the second closest delivery agent's application 110 over the communication network 104, and if the second closest delivery agent does not respond with an availability communication, the system 100 issues a third ‘push’ notification routed to the third closest delivery agent's application 110 over the communication network 104. In at least one embodiment of the present disclosure, the system 100 may issue a blanket notification routed over the communication network 104 to the delivery agent applications 110A of all delivery agents that are available to perform deliveries, as further disclosed herein.

In at least one embodiment of the present disclosure, the delivery agent application 110A may only receive a ‘push’ notification routed over the communication network 104 if the delivery agent associated with delivery agent application 110A meets certain criteria, as determined by the system 100. For example, a delivery agent 110A may be suited towards a particular type of delivery, such as, for example, a delivery of a large order, or a delivery to a distant destination. In at least one embodiment of the present disclosure, the system 100 may seek delivery agents to fulfill delivery demands based on an individual delivery agent type, delivery agent attributes, or the order attributes. For example, the system 100 may comprise a plurality of delivery agents such as, a driver with a car, or a bicyclist. A delivery order ready to be delivered may comprise a quantity of items that a bicyclist may not be able to deliver. For example, if a delivery order comprises ten pizzas, and if delivery agent application 110A has an attribute of a bicycle mode of transportation, the system 100 evaluates the delivery agent application's 110A suitability to handle, transport, and deliver a particular order, for example ten pizzas. The system 100 may determine that delivery agent associated with delivery agent application 110A is not ideal to deliver ten pizzas, and the system 100 will select a delivery agent with, for example a car as the delivery agent attribute indicated for the delivery agent application 110A. Conversely, if the delivery order comprises one sandwich, and the delivery location is two blocks from the kitchen facility, the system 100 may select a bicycle as the delivery agent attribute indicated for the particular delivery agent application 110A, given that a bicyclist may be more efficient than a car driver, or it may be that the car driver is slotted to deliver a large order that the bicyclist cannot deliver. It will be appreciated that the system 100 is configured to evaluate order attributes indicated, and to pick a delivery agent associated with a delivery agent application 110A that has transportation attributes that can service the order attribute. In another example, if the order contains ice cream, the order attribute may indicate that the order must be transported in a chilled environment. In such a case, the system 100 may be configured to prioritize a delivery agent application 110A that has a transportation attribute associated with it that includes a cooled vehicle, as opposed to a pedestrian, to ensure successful delivery of the ice cream order. In such embodiments, the communications router of the system 100 will route communications over the communication network 104, illustratively in the form of ‘push’ notifications to delivery agent applications 110A associated with delivery agents having attributes meeting the requisite order attributes. In one embodiment of the present disclosure, a delivery agent logs in or otherwise indicates available status through the delivery agent application 110A and selects a transportation attribute that represents to delivery agent's mode of transportation for deliveries during that session for which the delivery agent wishes to remain available for deliveries.

In at least one embodiment of the present disclosure, the system 100 may be configured to have a priority or preference towards delivery agents that have placed their delivery agent application in an ‘available’ state and are physically close to the kitchen facility, such that the delivery agent can reach the kitchen facility promptly.

In at least one embodiment of the present disclosure, the system 100 may include a plurality of kitchens having kitchen manager applications (e.g. kitchen manager application 108A and kitchen manager application 108B). The system 100 may further select a delivery agent associated with a delivery agent application 110A based on the delivery agent application's 110A (or the delivery agent device's 112A) location relative (or calculated or estimated time to travel) to each of the plurality of kitchens. For example, delivery agent application 110A may indicate a position farthest away from the kitchen facility associated with kitchen manager application 108A, but may be closer to another kitchen facility associated with kitchen manager application 108B, and any orders received by system 100 and routed (such as through a communication router over the communication network 104) to kitchen manager application 108B may now be delivered by the associated delivery agent.

In at least one embodiment of the present disclosure, if the order is not scheduled, the system 100 attempts to determine if the number of active delivery agents is less than the number of open orders without a delivery agent assigned (or that the number of active delivery agents has dropped below an established threshold, whether on a percentage or fractional basis, whole number difference, or other metric which would be known to one of ordinary skill in the art). If so, the system 100 may be configured to send a ‘push’ notification, such as through a communication router over the communication network 104, to one or more delivery agent applications 110A to obtain additional delivery agents who have indicated ‘available’ status, as further disclosed herein. A ‘push’ notification is indicative that an additional delivery agent is required by the system 100. In some embodiments, the number of delivery agents selected to receive ‘push’ notifications is selected at least in part based on the pickup time and/or the requested delivery time.

In at least one embodiment of the present disclosure, the system 100 may attribute order characteristics to each order. For example, an order comprising more than ten food items may be considered a large order; or an order expected to weigh more than a certain threshold limit (e.g., 15 lbs) may be considered a large order. In at least one embodiment of system 100, particular food items may have attribute information associated therewith such as weight, temperature (such as hot, cold, or neutral), and spillability included. Additionally, order attributes may also comprise any information about the specialized nature of the food item or the order, such as for example, whether the order contains liquids (e.g. beverages), or whether the order has any temperature constraints (e.g. if the order includes ice cream, a temperature constraint may be in place to ensure the ice cream does not melt before delivery). The system 100 may be configured to issue instructions for packaging or delivery for mixed orders (such as packaging hot items with only other hot or hot and neutral items, or delivering food items having an easy-to-spill attribute in special packaging or transportation instructions provided to the delivery agent).

In at least one embodiment of the present disclosure, the method 200 further includes step 206, of queuing an order. The system 100 may queue an order in order queue 106A. For example, an order may be placed in the order queue 106A so that it may be held until the system 100 receives confirmation from delivery agent associated with delivery agent application 110A, such as through a communication router over the communication network 104, that the delivery agent associated with delivery agent application 110A has accepted the ‘push’ notification from the system 100, and is on the way to the kitchen facility for pickup of the order (as further disclosed at step 208). It will be appreciated that every order may be queued in order queue 106A and may not be dispatched to be cooked until the system 100 receives confirmation that a delivery agent will be (or is) available to pick up and deliver the order, as soon as possible, upon cooking completion of the order. It will be further appreciated that an order may stay in the order queue 106A so long as a delivery agent associated with delivery agent application 110A is not available (See FIG. 3—order 6 stays queued from time period 8 until time period 16 while waiting for an acknowledgment from Delivery Agent 3); or the order may be almost instantaneously dispatched for cooking upon the system 100 receiving almost instantaneous confirmation from delivery agent 110A (See FIG. 3—order 5 is immediately dispatched after being received upon receiving the acknowledgement from Delivery Agent 4).

In at least one embodiment of the present disclosure, the method 200 includes receiving delivery agent acknowledgement, at step 208. As disclosed above, the system 100 issues a ‘push’ notification, through a communication router over the communication network 104, to all available delivery agent applications 110A to request the availability of a delivery agent to fulfill the delivery requirements of the order. In at least one embodiment of the present disclosure, a delivery agent associated with delivery agent application 110A can transition between various statuses as further disclosed herein. It will be appreciated that when the system 100 issues a ‘push’ notification requesting a delivery agent associated with delivery agent application 110A, the first ‘available’ delivery agent may operate delivery agent device 112A to accept the request from the system 100 via the delivery agent application 110A, and then transition to the ‘en-route’ status, whereby the delivery agent associated with delivery agent application 110A is then en-route to the kitchen facility.

In at least one embodiment of the present disclosure, the method 200 further includes the step of dispatching the order, at step 210. In at least one embodiment of the present disclosure, the system 100 operates to dispatch the order (i.e. each of the items comprising an order) from the order queue 106A of server 106 to the kitchen manager application 108A, such as through the communication router of system 100 over the communication network 104. In at least one embodiment of the present disclosure, the system 100 operates to compute food preparation times, in order to ensure that the each food item is completed at or about the same time as each other food item in the order. At least one embodiment the system 100 operates to compute food preparation times, in order to ensure that the each food item is completed at or about the same time as when the delivery agent associated with delivery agent application 110A arrives at the kitchen to pick up the order for immediate delivery to the customer. At least one embodiment of the system 100 operates to compute food preparation times, in order to ensure that the each food item is completed at or about the same time under circumstances when one or more food station has a backlog, delays, or some other sensed or reported issues resulting in a delay.

In at least one embodiment of the present disclosure, the system 100 may assign a ‘wait’ time for a particular item in the food order, in order to delay beginning the preparation of the item such that it is completed at the same time as another item that may have taken a longer time to cook (i.e. wait time=delivery agent associated with delivery agent application 110A's estimated time of arrival (ETA)—cook time). The customer's requested delivery time may also be taken into account when computing the wait time so that the food order is completed at such a time that it can be delivered to the customer at the requested delivery time.

For example, if an order includes a Cuban sandwich that takes ten minutes to prepare, and a hamburger that takes four minutes to prepare, and the delivery agent associated with delivery agent application 110A will not be available until fifteen minutes from the time the order was placed, the system 100 is operably configured to dispatch food item orders to the food station manager application, such as through a communication router over the communication network 104, so that the items are ready exactly when, or as close to when, the delivery agent associated with delivery agent application 110A is ready to pick up the order for delivery. In the example, the system 100 will first queue the Cuban sandwich to begin cooking in approximately five minutes (i.e. delivery agent's ETA (15 minutes)—Cuban sandwich cook time (10 minutes)=wait time (5 minutes)); similarly, the system 100 will queue the hamburger to begin cooking in approximately 11 minutes (i.e. delivery agent's ETA (15 minutes)—hamburger cook time (4 minutes)=11 minutes). After queued, the system 100 will display the items to be prepared at the appropriate food station manager application. It will be appreciated that the system 100 will queue the food items such that all the food items are completed at or near the same time, and at such time as when the delivery agent associated with delivery agent application 110A is ready to take the order to be delivered.

In at least one embodiment of the present disclosure as shown in flowchart 300, order 1 is placed at time period 1, and contains five items. At time period 1, the order is received at server 106 over the communication network 104. At time period 2, order 1 is queued in order queue 106A, and the system 100 issues a ‘push’ notification through a communication router over communication network 104 to delivery agent application 110A. At time period 3, the delivery agent associated with delivery agent application 110A (as shown at 308), ‘acknowledges’ the ‘push’ notification through a communication router over communication network 104, indicative that the delivery agent associated with delivery agent application 110A is en-route to the kitchen facility in order to fulfill delivery of an order request. Continuing with this example, at time period 3, the server 106 ‘releases’ the order from the order queue 106A, while determining the ‘wait’ time for each item. Order 1, item 1, takes 6 time periods to cook; order 1, item 2, takes two time periods to cook; order 1, item 3, takes five time periods to cook; order 1, item 4, takes six time periods to cook; and order 1, item 5 takes eight time periods to cook. In at least one embodiment of the present disclosure, the system 100 determines the estimated arrival time of the delivery agent 1 based on the distance (as determined by the location of delivery agent 1), from the kitchen facility. Continuing with the above example, if it is estimated that delivery agent 1 is expected to arrive at time period 12, the system 100 operates to calculate wait times for each order item based on their predetermined preparation times. In the present example, order 1, item 1, will ‘wait’ to be dispatched for two time periods (i.e. time period 4-5); order 1, item 2, will ‘wait’ to be dispatched for six time periods (i.e. time periods 4-9); order 1, item 3, will ‘wait’ to be dispatched for three time periods (i.e. time period 4-6); order 1, item 4, will ‘wait’ to be dispatched for two time periods (i.e. time periods 4-5); and order 1, item 5 will ‘wait’ to be dispatched for zero time periods. Therefore, the each of the items in order 1 will be completed at or about the same time as when a delivery agent will be available to take possession of the order and engage in the delivery process (i.e. at time period 12).

In at least one embodiment of the present disclosure, the system 100 may be pre-populated with estimated cooking times for all food items contemplated to be cooked in the kitchen facility at the applicable food stations. The cook times are used to establish wait times and/or start times for food items in a particular order, and instructions are sent, whether through the communication network 104 using the communication router or through some other means known to one of ordinary skill in the art, to the food station manager applications to provide instructions to the workers. In some embodiments, the instructions are sent to the kitchen manager application 108A which then sends instructions to the appropriate food station manager applications for item preparation). It will be further appreciated that the system 100 may keep track and ‘learn’ of cook times for any items that are cooked at the applicable food stations, and further update and modify the estimated cook times for the each of the food items, based on such historical data. In at least one embodiment of the present disclosure, the system 100 may also track order item cooking time to continuously update the expected cooking time for each food, and/or for other items in a given order (whether real time adjustment for particular orders and other order calculations, or for historical aggregation and analytics). For example, if a hamburger was originally determined to be cooked in four minutes, but actual cooking time repeatedly indicates that it takes five minutes to prepare, the system 100 may be configured to update the expected cooking time for the hamburger as appropriate. Alternatively, the system 100 may present information (e.g. a list of observed differentials of actual cook times versus expected system cook times), to an expo or other management personnel, to allow a determination of whether to adjust the cook time in the system 100, improve training for the cook responsible for the food item, improve kitchen work flow, or take some other appropriate action to resolve the disparity between expected system cook times and actual cook times. It will be appreciated that the system 100 is capable of tracking food item cooking time based on when each food station starts cooking the food item, and when it ends cooking the food item, as input to the food station manager application by the cook manning the food station.

In at least one embodiment of the present disclosure, the system 100 may modify ‘wait’ times in order to account for changes in the estimated arrival time of the delivery agent associated with delivery agent application 110A. Continuing with the above example, order 1 was initially released form the order queue 106A based on the acknowledgement received from delivery agent 1 through the communication router over the communication network 104. Whereas delivery agent 1 was originally scheduled to arrive at the kitchen facility at time period 12, delivery agent 1 actually arrived at kitchen facility at time period 10. However, in the present example, the system 100 did not have to modify the preparation schedule of order 1 given that delivery agent 3 was expected to arrive at time period 12. It will be appreciated that a delivery agent is not “tied” to an order, and that a delivery agent is only selected in at least one embodiment at the moment the order is completed and ready to be handed to a delivery agent for delivery. It will be further appreciated that by not tying a delivery agent to a particular order, the system 100 is allowed to process orders on a first come, first served basis, while at the same time ensuring that the first driver that is immediately available upon the completion of the cooking of the order is the delivery agent to handle the order, thereby ensuring the quickest possible time from the time an order is cooked, to the time it is delivered (i.e. the food order is not ‘waiting’ to be delivered, and is immediately dispatched for delivery after being cooked/prepared).

In at least one embodiment of the present disclosure, the method 200 further includes receiving at the order queue 106A, from the food station manager application, through a communication router over the communication network 104, a food item started confirmation for each item in an order to establish when the food item commenced cooking or preparation.

In at least one embodiment of the present disclosure, the method 200 further includes receiving an order prepared confirmation, at step 212. For each item that is dispatched to a food station manager application in the kitchen facility, the food station manager application is configured to signal (or sense or receive an input from a cook regarding) the completion of the preparation of the item. System 100 receives this information over the communication network 104 and may use the information regarding item start time and item finish time to track actual item preparation times versus predetermined item preparation times. In at least one embodiment of the present disclosure, if an order comprises a plurality of individual food items, each of the food items are combined for delivery (for example, by a workforce member or the runner station). When the order is completely “assembled,” a member of the workforce transfers the food item to a delivery agent, as further disclosed herein.

In at least one embodiment of the present disclosure, the method 200 further includes assigning a delivery agent associated with delivery agent application 110A, at step 214. When an order is completely assembled, a workforce member will provide the order to a delivery agent associated with delivery agent application 110A who is in the vicinity of the kitchen facility (e.g. in the parking lot by the kitchen facility; or at a pre-assigned location near the kitchen facility; or in a line along with other delivery agents). For example, a workforce member responsible for assembling the order may also select the first delivery agent in a line of delivery agents. In some embodiments, the server 106 assigns the order to one of the delivery agents who is calculated to arrive at the pick-up location at or before the order ready time. In at least one embodiment of the present disclosure, a workforce member may operate a delivery screen at a expo station and select a dropdown of “arrived” delivery agents and provide a selected delivery agent with the order. Upon getting the food, the delivery agent 110A will transition to a new state to indicate that he/she is in the process of delivering the order, and start driving to the delivery destination.

Referring now to FIG. 2B, there is shown an exemplary embodiment, at 250, of the method 200, according to one embodiment of the present disclosure. In the exemplary embodiment 250, the customer places an order and the order is received at the server 106 through a communication router over the communication network 104, as shown at 252. The server 106 estimates an order completion time and requests a delivery agent by issuing a ‘push’ notification to a delivery agent application 110A through a communication router over the communication network 104, at 254. The server 106 also adds the order to order queue 106A, at 256. The delivery agent associated with delivery agent application 110A receives the ‘push’ notification and acknowledges the same (also through a communication router over the communication network 104) at 258. At 260, the server 106 releases the order from the order queue 106A, and dispatches the order to the appropriate food station manager applications through a communication router over the communication network 104. As shown in exemplary embodiment 250, the order has three order items—order item #1, order item #2, and order item #3. In the exemplary embodiment 250, the server 106 determines the estimated arrival time of the delivery agent associated with delivery agent application 110A, based on when the delivery agent acknowledged the ‘push’ notification (i.e. at 258), and how far away the delivery agent is from the kitchen facility. The delivery agent associated with delivery agent application 110A is expected to begin travelling to the kitchen facility at 262, and arrive at the kitchen facility at 264. In the exemplary embodiment 250, the server 106 dispatches order item #1 first, at 260A; order item #3 is delayed and dispatched at 260C; and order item #2 is delayed and dispatched last at 260B. It will be appreciated that the each of the order items are dispatched such as through the communication router of the system 100 over the communication network 104, and are dispatched at particular times so that they all are completed at about the same time (i.e. at 264). At 264, all the order items are cooked/prepared and are ready for delivery, and the delivery agent associated with delivery agent application 110A arrives at the same time, or substantially around the same time. The delivery agent takes possession of the order at 264, and then proceeds to travel to the customer to deliver the order at 268. It will be appreciated that dispatching, such as using the communication router and communications network 104 of the system 100, each of the order items at different times ensures that each of the items are completed at the same. It will be further appreciated that by completing each item at the same time, the entire order may be delivered quickly and the items are not left ‘sitting’ and thus be diminished in quality upon delivery.

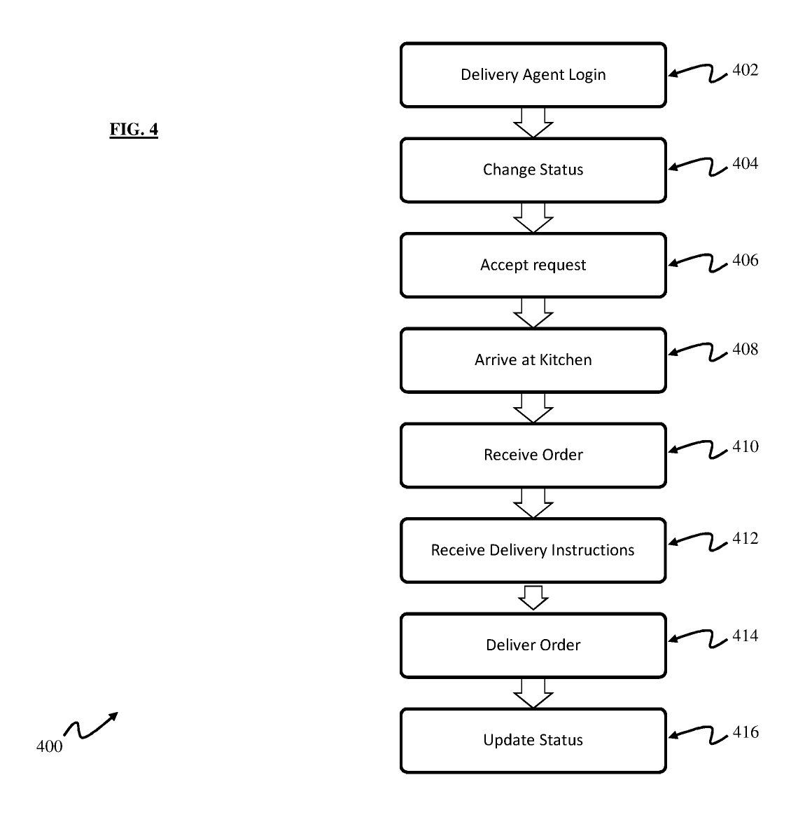

Referring now to FIG. 4, there is shown a method for coordinating food preparation and delivery, generally indicated at 400. In at least one embodiment of the present disclosure, the method 400 includes a delivery agent logging in using delivery agent application 110A at step 402; the delivery agent changing status using delivery agent application 110A at step 404; the delivery agent using delivery agent application 110A to accept a request at step 406; the delivery agent associated with delivery agent application 110A arriving at the kitchen facility associated with kitchen manager application 108A at step 408; the delivery agent receiving the order at the kitchen facility at step 410; the delivery agent delivering the order and confirming the order was delivered using delivery agent application 110A at step 414; and the delivery agent using delivery agent application 110A to update the delivery agent's status at step 416 (for example to remain active or available, or to deactivate).

In at least one embodiment of the present disclosure, the method 400 includes the delivery agent logging in using delivery agent application 110A at step 402. The delivery agent using delivery agent application 110A may be able to access the system 100 using login credentials, or federated access from other third party applications (e.g Facebook®), operably connected to the system 100 via the Internet. In at least one embodiment of the present disclosure, the delivery agent associated with delivery agent application 110A may change their status (e.g. unavailable (i.e. the delivery agent is not available to perform any deliveries); or active/available (i.e. the delivery agent is available to fulfill a delivery)).

In at least one embodiment of the present disclosure, step 402 may further include the delivery agent using delivery agent application 110A (via the delivery agent device 112A) to transmit information to the system 100 through a communication router over the communication network 104. In at least one embodiment of the present disclosure, the delivery agent information may include the delivery agent's state selected by the delivery agent using delivery agent application 110A (e.g. available, not available, in transit, on task, at kitchen, etc.) or assigned by the system (such as assigning status of not available when a delivery agent fails to indicate s/he wishes to remain active after a set time has elapsed), delivery agent application 110A attribute (e.g. car, truck, bicycle, refrigerated, etc.), or route information (such as heavy traffic between delivery agent associated with delivery agent application 110A's current location and kitchen facility), and delivery agent application's 110A location (e.g. GPS coordinates). In other embodiments, the server 106 obtains the delivery agent's location from the delivery agent device 112A or from another ‘device maintained at the delivery agent's location. In at least one embodiment of the present disclosure, the system 100 will send (such as through a communication router over the communication network 104) to the delivery agent application 110A pickup location information such as, an image, GPS coordinates, address, or other identifiable location information, as will be appreciated by one having ordinary skill in the art. The system 100 may further send (such as through a communication router over the communication network 104) a notification to an ‘available’ or ‘active’ delivery agent application 110A about a delivery job that the delivery agent associated with delivery agent application 110A can undertake.

In at least one embodiment of the present disclosure, the method 400 includes the delivery agent changing status using delivery agent application 110A, at step 404. The delivery agent using delivery agent application 110A can transition between various status states. For example, unavailable means the delivery agent is not available to perform any deliveries; and ‘active/available’ means the delivery agent 110A is available to fulfill a delivery. In at least one embodiment the status states can include, for example: unavailable (i.e. the delivery agent associated with delivery agent application 110A is not available to perform any deliveries); active/available (i.e. the delivery agent associated with delivery agent application 110A is available to fulfill a delivery); busy (i.e. the delivery agent 110A is engaged in the fulfillment of a delivery); and en-route (i.e. the delivery agent 110A is en-route to the kitchen facility). For example, an ‘active/available’ state means the delivery agent 110A has opened a delivery agent application 110A on the delivery agent device 112A and indicated that he/she is willing to “start working” but that he/she has not yet been dispatched to the kitchen facility. The change in status is indicative that the delivery agent associated with delivery agent application 110A wants to receive ‘push’ notifications to begin working. ‘En-route’ means that the delivery agent associated with delivery agent application 110A is on the way to the kitchen facility ready to pick up an order when he/she gets there. The delivery agent associated with delivery agent application 110A may enter into this state by receiving a ‘push’ notification through a communication router over the communication network 104 while in ‘available’ state (or by opting to remain active after delivering an order, as further disclosed herein). ‘Busy’ means the delivery agent associated with delivery agent application 110A has an order, has picked up the order from the kitchen facility, and is en-route to deliver the order to the customer. ‘Unavailable’ means the delivery agent associated with delivery agent application 110A is neither working nor wanting to receive ‘push’ notifications.

In at least one embodiment of the present disclosure, the method 400 includes the delivery agent using delivery agent application 110A to accept a request, at step 406. A delivery agent application 110A may receive a ‘push’ notification through a communication router over the communication network 104 if the delivery agent using the delivery agent application 110A is in the ‘available’ state, and the system 100 requires a delivery agent to fulfill delivery of an order. In at least one embodiment of the present disclosure, the delivery agent may use the delivery agent application 110A to accept such a notification within a certain pre-defined time threshold, whereby if the time threshold is exceeded, the delivery agent associated with delivery agent application 110A is no longer “offered” the ability to accept the ‘push’ notification.

In at least one embodiment of the present disclosure, the method 400 includes detecting or otherwise receiving indication that the delivery agent associated with delivery agent application 110A arrived at the kitchen facility, at step 408. After accepting the ‘push’ notification using delivery agent application 110A, the delivery agent 110A transitions to the “en-route” state, indicative that the delivery agent associated with delivery agent application 110A is en-route to the kitchen facility. During the period of travel, the delivery agent using delivery agent application 110A may exchange information with the system 100 through a communication router over the communication network 104, such as, for example, the delivery agent and the associated delivery agent application's 110A location, the speed of travel, and the like. Upon arrival at the kitchen facility, the delivery agent application 110A may indicate the delivery agent's arrival by transitioning to the “arrived” state, indicative that the delivery agent is on the kitchen facility premises. It will be appreciated that the system 100 may automatically transition the delivery agent application 110A to the “arrived” state based on the location of the delivery agent application 110A, or based on the delivery agent using delivery agent application 110A such as through operation of the delivery agent device 112A, to indicate the same.

In at least one embodiment of the present disclosure, the method 400 includes the delivery agent associated with delivery agent application 110A receiving the order, at step 410. In at least one embodiment, a workforce member in the kitchen facility may be instructed to and be responsible for handing the order to the delivery agent. It will be appreciated that in at least one embodiment, there is minimal effort on the part of the delivery agent to gain possession of the order from the kitchen facility. For example, if the delivery agent associated with delivery agent application 110A is associated with a car, the delivery agent may not have to exit his car; rather, a workforce member of the kitchen facility will approach the car and hand the order into the car to the delivery agent. It will be further appreciated that this reduces the overall delivery time of the order given that the delivery agent does not have to be concerned with having the right order, or ensuring the completeness of an order comprising many individual items. This “grab-and-go” approach ensures that the delivery agent is engaged solely in the pick-up and delivery process. As discussed hereinabove, in some embodiments delivery agents are not assigned to orders until they actually receive the order. So that the system 100 knows which delivery agent application 110A has been tasked with delivering the order, in some embodiments a code is printed on the order or on a ticket or the like associated with the order. After receiving the order, the delivery agent may enter the code into the delivery agent application 110A to let the system 100 know that this delivery agent has picked up the order for delivery. The system 100 can thereafter send delivery instructions through a communication router over the communication network 104 to the delivery agent's delivery agent application 110A and track the progress of the delivery to the customer.

In at least one embodiment of the present disclosure, the method 400 includes the delivery agent associated with delivery agent application 110A receiving delivery instructions at step 412. As discussed hereinabove, concurrent to, or around the same time as, when the delivery agent associated with delivery agent application 110A receives the order at step 410, the delivery agent application 110A also receives delivery instructions. In at least one embodiment of the present disclosure, the delivery agent application 110A may be provided with routes, special handling instructions, entry and access directions (e.g. security code to a customer's building), and the like. It will be appreciated that the system 100 may automatically transmit, such as through a communication router over a communication network, such information to the delivery agent application 110A (or to the delivery agent device 112A), or such information may be manually entered by a delivery agent into the delivery agent device 112A.

In at least one embodiment of the present disclosure, the method 400 includes the delivery agent associated with delivery agent application 110A delivering the order, at step 414. The delivery agent associated with delivery agent application 110A proceeds to the customer's desired destination as per instructions. During the delivery agent's delivery, the delivery agent's location may be tracked to provide the customer with insight into the delivery agent's progress, and the estimated arrival time to customer's location. In at least one embodiment of the present disclosure, the system 100 may generate pre-populated texts for the delivery agent to send, such as through a communication router over the communication network 104 of system 100 or from the delivery agent device 112A. The messages may include information such as order information, delivery agent information (such as type of car, bike, hat, or attire, for example), estimated time of arrival, and location information, to name a few non-limiting examples.

In at least one embodiment of the present disclosure, the system 100 allows for a delivery agent associated with delivery agent application 110A to obtain a daily delivery agent summary, which includes information such as, for example, date, day of the week, base monies, tips, total amount earned, recent jobs (including duration of delivery), number of items, pay rate, feedback, rating, address, and location.

In at least one embodiment of the present disclosure, the method 400 includes the delivery agent updating status through delivery agent application 110A at step 416. When the food order is handed off to the customer, the delivery agent associated with delivery agent application 110A indicates that the order delivery has been completed (e.g. via the operation of the delivery agent device 112A) and is given the option to keep working or stop working. If the delivery agent associated with delivery agent application 110A elects to keep working, the delivery agent associated with delivery agent application 110A will automatically transition to the ‘active’ state and is given priority for any additional orders that the system 100 receives. If the delivery agent associated with delivery agent application 110A elects to stop work, the delivery agent associated with delivery agent application 110A will enter the ‘unavailable’ state. It will be appreciated that the method 400 allows the delivery agent associated with delivery agent application 110A to have control over his/her work schedule, and also gives priorities to delivery agents who remain and continue working. It will be further appreciated that the method 400 does not have to over-subscribe the number of delivery agents to activate, which is the result when all delivery agents are treated with equal priority. It will also be further appreciated that the method 400 ensures delivery agents who are already “working” will continue to receive delivery tasks, thereby providing additional assurances to delivery agents that they can continue earning money.

While the description above refers to particular embodiments of the present invention, it will be understood that many modifications may be made without departing from the spirit thereof. The accompanying concepts are intended to cover such modifications as would fall within the true scope and spirit of the present invention. The presently disclosed embodiments are therefore to be considered in all respects illustrative and not restrictive, the scope of the invention being indicated by the appended concepts, rather than the foregoing description, and all changes which come within the meaning and range of equivalency of the concepts are therefore intended to be embraced therein.

For example, although the present invention has been described as useful for the food order, preparation and delivery industry, those of skill in the art will readily understand and appreciate that the present invention has substantial use and provides many benefits in other industries as well. Some of those may include practicing the present invention to improve ordering, manufacture, and delivery efficiencies of products and services such as general product manufacturing and/or assembly, e-commerce web store, or an on-demand taxi services company. In general, one having ordinary skill in the art would find the present invention useful in improving production, and delivery of on-demand products and services.

What is claimed is:

1. A method for transmitting an instruction communication to a manager application from a server including a communication router coupled to a communication network, for preparation and delivery of an order placed through a customer order placement application in communication with the server, the instruction communication being based upon information received from a delivery agent application associated with each of a plurality of delivery agents, the method comprising the steps of:
a. receiving, at the server, an order communication from the customer order placement application, the order communication comprising an order for one or more items placed by a customer for delivery to a delivery destination;
b. determining, by the server, an estimated preparation time for each of the one or more items;
c. receiving, at the server, an availability communication from the delivery agent application for a first one of the plurality of delivery agents, the availability communication comprising a delivery agent status;
d. receiving, at the server, a location communication from at least one of: a device associated with the first one of the plurality of delivery agents or the delivery agent application for the first one of the plurality of delivery agents, the location communication comprising a location of the first one of the plurality of delivery agents;
e. determining, at the server, an estimated arrival time of the first one of the plurality of delivery agents at a pickup location based at least in part on the location of the first one of the plurality of delivery agents;
f. determining, at the server, a preparation start time for each of the at least one items in the order such that preparation of the each of the at least one items is completed substantially simultaneously to each of the other at least one items, and substantially simultaneously with the estimated arrival time of the first one of the plurality of delivery agents at the pickup location; and
g. transmitting, by the communication router, an instruction communication over the communication network to the manager application to begin preparation of each of the at least one items at the preparation start time for each of the at least one item.

2. The method of claim 1, wherein the order comprises a food order, the one or more items comprises one or more food items, and the manager application comprises a kitchen manager application.

3. The method of claim 1, further comprising the step of (h) receiving from the manager application, at the server, a confirmation communication when each of the at least one items of the order has been prepared.

4. The method of claim 1, further comprising the step of (h) assigning, by the server, the order to the first one of the plurality of delivery agents.

5. The method of claim 1, wherein the preparation start time for each of the one or more items equals the estimated arrival time of the first one of the plurality of delivery agents at the pickup location, minus a predetermined preparation time for each of the one or more items.

6. A method for transmitting an instruction communication to a manager application from a server including a communication router coupled to a communication network, for preparation and delivery of an order placed through a customer order placement application in communication with the server, the server further operative to communicate over the communications network with a plurality of delivery agent applications associated with each of a plurality of delivery agents, the method comprising the steps of:
a. receiving, at the server, an order communication from the customer order placement application, the order communication comprising an order for one or more items placed by a customer for delivery to a delivery destination;
b. communicating, by the server, with at least one of: a device associated with a delivery agent or one of the plurality of delivery agent applications associated with the delivery agent, and determining based on the communication the arrival time of the delivery agent at a pickup location;
c. determining, at the server and based at least partially on the arrival time, a preparation start time for each of the one or more items; and
d. transmitting, by the communication router over the communication network to the manager application, an instruction communication to begin preparation of each of the one or more items at the respective preparation start time for each of the one or more items so that completion of preparation of each of the one or more items in the order substantially coincides with the completion of preparation of each of the other items in the order and coincides with the arrival time of the delivery agent.

7. The method of claim 6, wherein the order comprises a food order, the one or more items comprises one or more food items, and the manager application comprises a kitchen manager application.

8. The method of claim 6 further comprising retrieving, by the server, data from a database regarding an estimated preparation time for each of the one or more items, wherein step (c) further comprises determining, at the server and based at least partially on the arrival time and the estimated preparation time, a preparation start time for each of the one or more items.

9. The method of claim 6, further comprising the step of (e) receiving, at the server, an availability communication from the delivery agent application associated with the delivery agent, the availability communication comprising a delivery agent status.

10. The method of claim 6, further comprising the step of (e) receiving from the manager application, at the server, a confirmation communication when each of the at least one items of the order has been prepared.

11. The method of claim 10 further comprising the step of (f) storing data in a database regarding a measured preparation time for each of the one or more items based upon the confirmation communication.

12. The method of claim 11, further comprising the step of (g) using said data to determine the estimated preparation time for each of the one or more items.

13. The method of claim 6, further comprising the step of (e) assigning, by the server, the order to the delivery agent.

14. The method of claim 6, wherein the preparation start time for each of the one or more items equals the arrival time of the delivery agent at the pickup location, minus a predetermined preparation time for each of the one or more items.

15. The method of claim 6, wherein step (b) includes receiving geolocation information from the delivery agent application.

16. The method of claim 6, wherein step (b) includes determining route information obtained from a database containing at least one route information.

17. The method of claim 6, wherein step (b) includes determining route information obtained from a database containing at least one route information and at least one traffic congestion information.

18. A computerized system coupled to a communication network, the system operative for assignment of an order to a delivery agent, the system comprising:
a. a customer order placement application;
b. a server for receiving an order communication from the customer order placement application over the communication network, the order communication comprising an order for one or more items placed by a customer for delivery to a delivery destination;
c. a database of item information comprising the time for completion of each of the one or more items;
d. an order queue for establishing a preparation sequence for each of the one or more items in each order based at least upon the time for completion of each of the one or more items; and
e. a plurality of delivery agent applications operative to send a plurality of communications over the communication network to the server, wherein each of the plurality of communications from the plurality of delivery agent applications comprises information regarding the location of the respective one of the plurality of delivery agent applications;
f. wherein the server identifies a delivery agent to pick up the order and an associated arrival time based at least in part on information in the plurality of communications and the order queue;
g. wherein the server determines, based at least in part on the arrival time, a preparation start time for each of the one or more items; and
h. wherein the server is operative to transmit, by the communication router over the communication network to the manager application, an instruction communication to begin preparation of each of the one or more items at the respective preparation start time for each of the one or more items so that completion of preparation of each of the one or more items in the order substantially coincides with the completion of preparation of each of the other items in the order and coincides with the arrival time of the delivery agent.

19. The system of claim 18, wherein a first delivery agent application suitable to fulfill the delivery of the order is selected from the plurality of delivery agent applications, based at least in part on a pre-determined criterion.

20. The system of claim 19, wherein the pre-determined criterion comprises a proximity of one of a device associated with the delivery agent or the first delivery agent application to a location where the order is completed.

21. The system of claim 19, wherein the pre-determined criterion comprises a length of time to travel a location of the first delivery agent application to a location where the order is completed.

22. The system of claim 19, wherein the pre-determined criterion comprises a transportation mode associated with the first delivery agent application.

23. The system of claim 19, wherein the server is operative to send an activation communication to the first delivery agent application and, if the first delivery agent application does not communicate an acceptance indication to the server, a second delivery agent application suitable to fulfill the delivery of the order is selected from the plurality of delivery agent applications based at least on the pre-determined criterion.

24. The system of claim 23, wherein the second delivery agent application communicates an acceptance indication to the server, and the server is operative to assign the order to the second delivery agent application for delivery to the customer.

25. The system of claim 18, wherein the order comprises a food order, the one or more items comprises one or more food items, and the manager application comprises a kitchen manager application.

26. The system of claim 18, wherein the server determines, based at least in part on the arrival time and the time for completion of each of the one or more items, a preparation start time for each of the one or more items.

27. The system of claim 18, wherein each of the plurality of delivery agent applications is configured to transmit to the server over the communication network, an availability communication, the availability communication comprising a delivery agent status.

28. The system of claim 18, wherein the manager application is configured to transmit to the server over the communication network, a confirmation communication when each of the at least one items of the order has been prepared.

29. The system of claim 28, wherein the server is configured to store data in a database regarding a measured preparation time for each of the one or more items based upon the confirmation communication.

30. The system of claim 29, wherein the server is configured to use said data to determine the estimated preparation time for each of the one or more items.
